(19) United States
(12) Patent Application Publication
(10) Pub. No.: US 2018/0101895 A1
(43) Pub. Date: Apr. 12, 2018

(54) AUTOMATED CUSTOM WEBSITE STOREFRONT CREATION

(71) Applicant: Focus!...On Innovation, Inc., Ponte Vedra, FL (US)

(72) Inventors: Daniel T. Buckles, Ponte Vedra Beach, FL (US); Daniel L. Green, Oviedo, FL (US)

(21) Appl. No.: 15/667,273

(22) Filed: Aug. 2, 2017

Related U.S. Application Data
(60) Provisional application No. 62/406,178, filed on Oct. 10, 2016.

(51) Int. Cl. G06Q 30/06

(52) U.S. Cl. CPC G06Q 30/0641; G06F 17/30887

(57) ABSTRACT

Method, system, and program product are disclosed for automating the creation of a customized website storefront including obtaining, using a processor, one or more bond characteristics. Once obtained, the bond characteristics may be used to automatically identify, from a reference table database, one or more data structures. The method, system or program product may then automatically generate, using a store content builder, a customized website storefront based on the data structures and store, in a network connected storage device, the customized website storefront. Once stored, a uniform resource locator (URL) to locate the stored customized website storefront may be generated, based on the one or more bond characteristics.

### CROSS REFERENCE TO RELATED APPLICATIONS

This application claims the benefit of priority of U.S. Provisional Patent Application Ser. No. 62/406,178, filed Oct. 10, 2016, entitled “Automated Custom Website Storefront Creation,” the entire contents of which is hereby incorporated by reference herein.

### BACKGROUND

A “surety bond” (sometimes simply called a “bond”) is a promise by a surety or guarantor to pay one party (i.e., an obligee) a certain amount of money if a second party (i.e., a principal) is unable to meet some earlier agreed upon obligation (e.g., fulfilling the terms of a contractual obligation). The fundamental purpose of a surety bond is to protect an obligee against losses resulting from the failure of a principle to meet the obligation.

In very general terms, a surety bond may be defined as a contract among at least three acting parties, the obligee (i.e., the party who is the recipient of an obligation), the principal (i.e., the primary party who will perform the contractual obligation), and the surety (i.e., the party who assures the obligee that the principal can perform the task). Typically, state insurance commissioners are responsible for regulating corporate surety activities within their jurisdictions. Thus, bond rules/guidelines can vary from state to state. Additionally, commissioners may also license and regulate brokers or agents to sell those bonds.

Due to all of the regulatory complications that are associated with bonds, and the changing of those regulations from state to state, it can be a complex process to purchase and/or sell bonds. Because of this complication, agents are generally required to assist a surety in the purchasing process. A surety must generally fill out a large number of forms and provide detailed personal information. The information in the forms may also be used to identify what, if any, bonds are available for purchase. This overly complex process is time consuming and burdensome for all involved. Thus, a solution is needed to help streamline the process of purchasing surety bonds, and make it a more consumer welcoming process.

### SUMMARY

In summary, one aspect provides a method for automating the creation of a customized website storefront comprising: obtaining, using a processor, one or more bond characteristics; automatically identifying, from a reference table database, one or more data structures based on the one or more bond characteristics; automatically generating, using a store content builder, a customized website storefront based on the data structures; storing, in a network connected storage device, the customized website storefront; and generating, based on the one or more bond characteristics, a uniform resource locator (URL) to locate the stored customized website storefront.

Another aspect provides an information handling device for automating the creation of a customized website storefront comprising: a processor; a display; a network connection device; and a non-transitory, processor-readable storage medium that stores instructions executable by the processor to: obtain one or more bond characteristics; automatically identify, from a reference table database, one or more data structures based on the one or more bond characteristics; automatically generate, using a store content builder, a customized website storefront based on the data structures; store the customized website storefront; and generate, based on the one or more bond characteristics, a uniform resource locator (URL) to locate the stored customized website storefront.

A further aspect provides a program product for automating the creation of a customized website storefront comprising: a storage device having code stored therewith, the code being executable by a processor and comprising: code that obtains one or more bond characteristics; code that automatically identifies, from a reference table database, one or more data structures based on the one or more bond characteristics; code that automatically generates, using a store content builder, a customized website storefront based on the data structures; code that stores, in a network connected storage device, the customized website storefront; and code that generates, based on the one or more bond characteristics, a uniform resource locator (URL) to locate the stored customized website storefront.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE DRAWINGS

For the purpose of illustrating the invention, there is shown in the drawings various embodiments, it being understood, however, that the invention is not limited to the specific instrumentalities disclosed as they are used for illustrative purposes only. Included in the drawings are the following Figures:

FIG. 1 depicts a method for automatically creating a custom website storefront.

FIG. 2 depicts an illustrative graphical user interface for creating a custom website storefront.

FIG. 3 depicts another illustrative graphical user interface for creating a custom web site storefront.

FIG. 4 depicts another illustrative graphical user interface for creating a custom web site storefront.

FIG. 5 depicts another illustrative graphical user interface for creating a custom web site storefront.

FIG. 6 depicts another illustrative graphical user interface for creating a custom web site storefront.

FIG. 7 depicts another illustrative graphical user interface for creating a custom web site storefront.

FIG. 8 depicts another illustrative graphical user interface for creating a custom web site storefront.

FIG. 9 depicts another illustrative graphical user interface for creating a custom web site storefront.

FIG. 10 depicts another illustrative graphical user interface for creating a custom web site storefront.

FIG. 11 depicts another illustrative graphical user interface for creating a custom web site storefront.

FIG. 12 depicts an illustrative example of custom node creation.

FIG. 13 depicts an illustrative graphical user interface for creating a user account within a custom web site storefront.

FIG. 14 depicts an illustrative graphical user interface for searching for a bond type in a custom web site storefront.

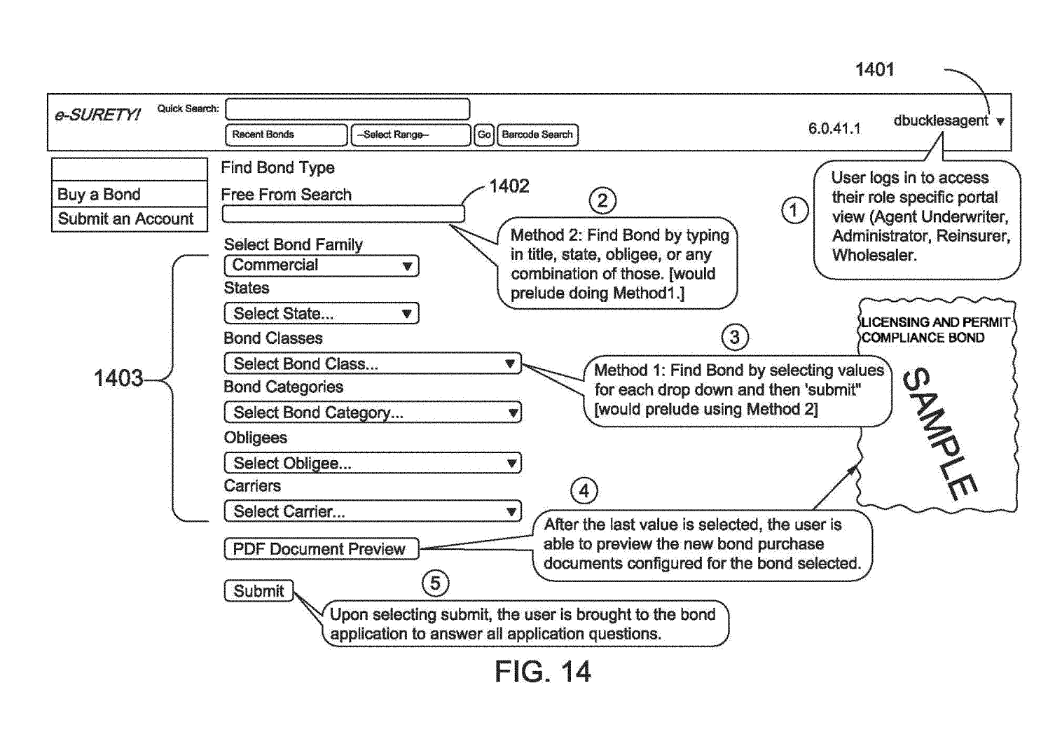

FIG. 15 depicts an illustrative graphical user interface for applying for a bond purchase in a custom website storefront.

FIG. 16 depicts another illustrative graphical user interface for applying for a bond purchase in a custom website storefront.

FIG. 17 depicts another illustrative graphical user interface for applying for a bond purchase in a custom website storefront.

FIG. 18 depicts an illustrative graphical user interface for building a bond in a custom website storefront.

FIG. 19 depicts another illustrative graphical user interface for building a bond in a custom website storefront.

FIGS. 20A and 20B depict another illustrative graphical user interface for building a bond in a custom website storefront.

FIG. 21 depicts another illustrative graphical user interface for building a bond in a custom website storefront.

FIG. 22 depicts a method for enabling a user to purchase one or more bonds.

FIG. 23 depicts an illustrative computer system for creating a customized web site storefront.

### DETAILED DESCRIPTION

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

As discussed herein, purchasing surety bonds can be a complex and timely process. Although the rise of the internet and the availably of advanced computers has somewhat impacted and opened up the general consumer market, it has not advanced the process of purchasing and/or managing surety bonds in any meaningful way. Currently, purchasing a bond generally requires the use of an agent, and specialized tools to identify what bonds are available and what forms and information are required to apply for said bonds. Thus, a solution is needed to streamline the process not only on the frontend (e.g., agent interaction and actual purchasing), but also in the backend (e.g., the creation of customized storefronts).

Accordingly, an embodiment provides a system and method for determining particular surety bond characteristics (e.g., agency type, state/regulator jurisdiction, bond classes, bond categories, etc.). Once an embodiment has obtained one or more of these various factors, a store content builder may determine what, if any, surety bonds are available for purchase that match the characteristics. Based on this determination, an embodiment may then automatically generate a customized user interface (e.g., agent/user portal) via a website or web interface referred to herein as a customized website storefront. The customized website storefront is then stored on a storage device connected to a network. A uniform resource locator (URL) may then be generated that points to the customized website storefront. The URL may then be sent via electronic mail (e-mail), hosted as a stand-alone website, incorporated into an existing website or the like to provide an agent or consumer with an easy to use tool to apply for and purchase a specific bond they desire.

In a further embodiment, a user (e.g., agent or consumer) may utilize the automatically generated custom storefront to facilitate the purchase of a surety bond. In an embodiment, a user may utilize various methods of identifying potential bonds. For example, an embodiment may comprise a search function to search all available or pending bonds. Additionally, it may be possible for a user to simply perform an internet search (e.g., with a typical search engine such as Google) which leads them to a hosted (i.e., published) customized website storefront where they can begin the application/purchase process. GOOGLE is a registered trademark of Google Inc. in the United States of America and other countries. Alternatively, an embodiment may provide a specific selection process (e.g., a user selects from a drop down list which further narrows a subsequent drop down list) as further discussed herein.

Thus, after the creation of the customized website storefront, an embodiment may push a user (e.g., carrier, agent, etc.) definable collection of bond product links to a web storefront in order to enable consumers to simply and easily select one or more bonds for which they wish to apply. In order to achieve this goal, an embodiment may be required to determine details specific to the underwriting of that particular bond. Once it determines what details are necessary, it may prompt a user to enter information, or obtain further information from previously entered information. Once the factors (e.g., personal user information, jurisdiction, etc.) are received, an embodiment may then automatically evaluate the details (e.g., answers to bond specific questions).

In the evaluation process, an embodiment may come to various conclusions. For example, an embodiment may determine the results to be any one of rejection, referral to underwriting for manual review, quotation, and the like. Thus, if all the details are deemed to automatically meet or exceed a set of provided underwriter rules, an embodiment may provide a quotation. In one embodiment, when an application is approved, as discussed herein, an email may be sent with a link to a specific quotation. The length of time a quotation is available for purchase to a user may be storefront dependent. Moreover, in one embodiment, the bond purchased from a customized website storefront may be unique to that individual storefront. A further embodiment may also allow for online payment to be made if the result of the evaluation is a quote. Thus, documents required for a legally binding bond may be issued and available for immediate printing/approval.

In order to perform the above tasks, an embodiment may have the ability to electronically gather additional underwriting information from public and subscription (e.g., private) sources that are specific to the applicant (e.g., user) and their personal and business history that permits additional underwriting risk evaluation that heretofore was not available to a surety from a single source.

Thus, the embodiments described herein present a technological improvement over the art that is necessarily rooted in computer technology (e.g., automatically building a customized website storefront) and amounts to a significant improvement over conventional systems. For example, an embodiment may be able to utilize reusable questions and rules set specific to each rule for each different bond offer. An embodiment may further generate multi-dimensional rating tables so that an end user can create a multi-axis table of any risk factors that at the intersection of values for each application using that table intersect at the appropriate rate table to use (i.e., years in business, credit score, type of business, etc.). As discussed herein, in one embodiment, each individual bond has a unique uniform resource locator (URL), which links the bond configuration to every agent so that any purchases of bonds from that specific link (i.e., URL) is credited to that agency.

The present invention may be a system, a method, and/or a computer program product. The computer program product may include a computer readable storage medium (or media) having computer readable program instructions thereon for causing a processor to carry out aspects of the present invention.

The computer readable storage medium can be a non-transitory tangible device that can retain and store instructions for use by an instruction execution device (e.g., one or more processors). The computer readable storage medium may be, for example, but is not limited to, an electronic, magnetic, optical, electromagnetic, semiconductor storage device, or any suitable combination of the foregoing. A non-exhaustive list of more specific examples of the computer readable storage medium includes the following: a portable computer diskette, a head disk, random access memory (RAM), read-only memory (ROM), erasable programmable read-only memory (EPROM or Flash memory), static random access memory (SRAM), a compact disc read-only memory (CD-ROM), a digital versatile disk (DVD), a memory stick, a floppy disk, a mechanically encoded device such as punch-card(s) or raised structures in a groove having instructions recorded thereon, and/or any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network (LAN), a wide area network (WAN), and/or a wireless network. The network may comprise conductive transmission cables (e.g., copper cables), optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

The illustrated example embodiments will be best understood by reference to the figures. The following description is intended only by way of example, and simply illustrates certain example embodiments.

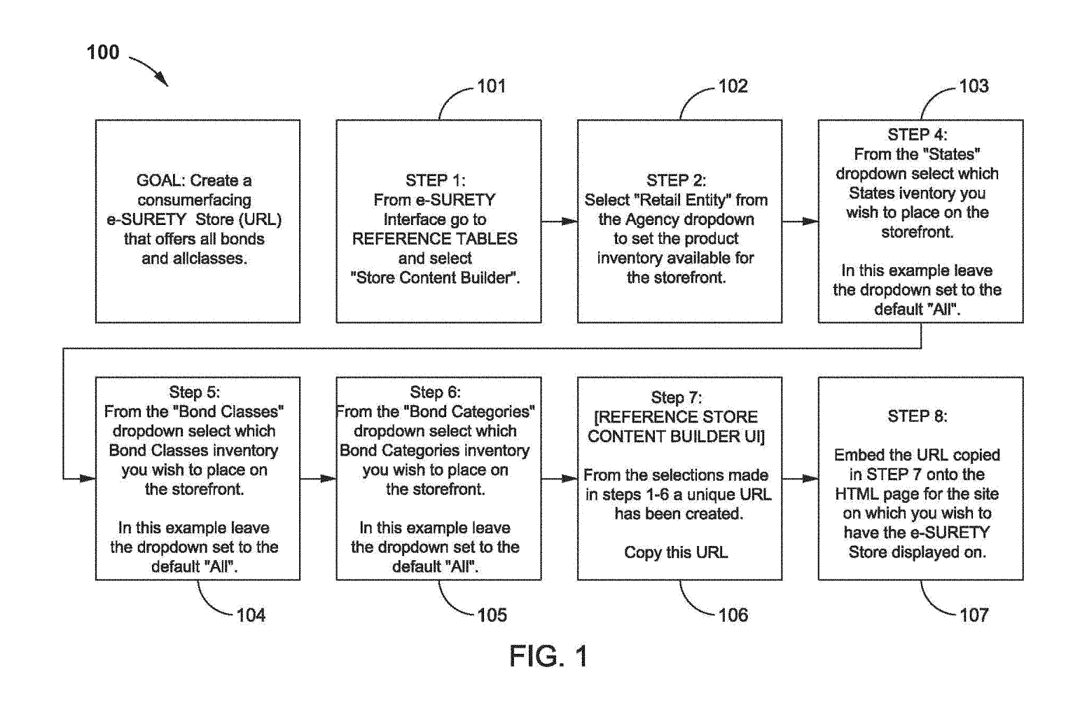

The process flow 100 of an embodiment is shown in FIG. 1. In one embodiment, a user (e.g., surety bond carrier) may utilize a computer input device to interact with a graphical user interface (GUI). Although the illustrated embodiments discussed herein are shown in the form of a website, it should be understood that this is simply a non-limiting illustrative example and that other embodiments may exist (e.g., stand-alone application).

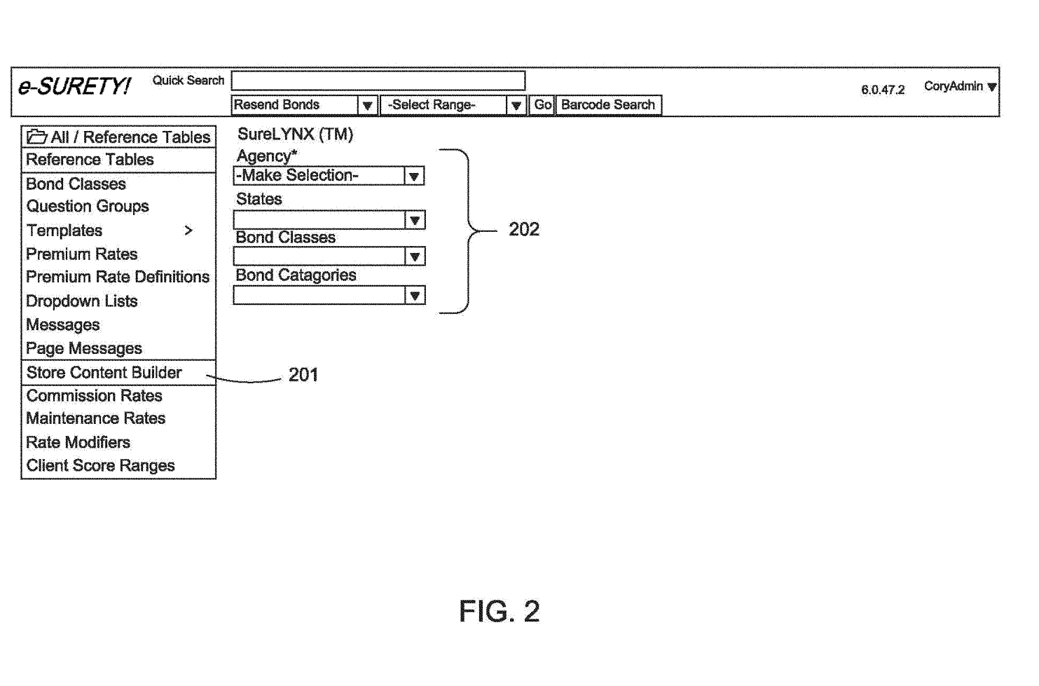

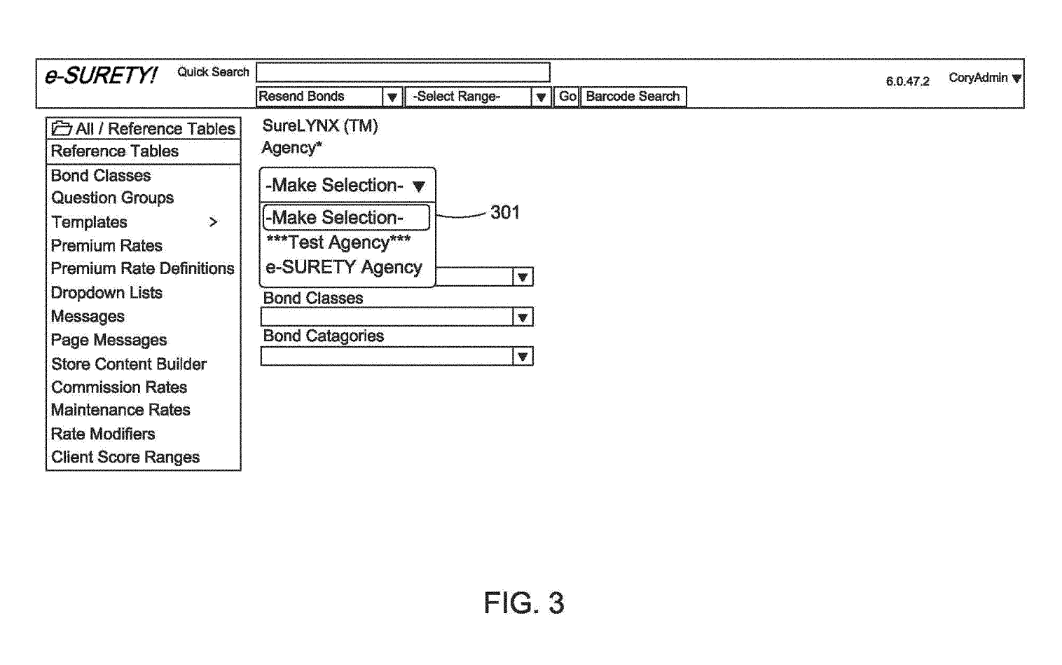

In one embodiment, a user may select the option to build a customized storefront at 101. Referring briefly to FIG. 2, an illustrative example is shown of a user selecting “store content builder” from the GUI 201 and in response, an embodiment may generate a store builder interface within the GUI 202. Once the “store content builder” options are loaded, a user may then begin to build their desired customized storefront. For example, a user may then select a “retail entity” from the agency drop down 102. In one embodiment, each retail entity (e.g., e-SURETY Agency) may be given access to specific content based on the administrator's direction. In a further embodiment, an administrator may be permitted to select a retail entity (e.g., Agency, Broker, etc.) to be associated with the store creation. In subsequent steps, as discussed herein, an administrator may set exactly what bonds will be accessible through the created storefront. As further shown in FIG. 3, an embodiment may have multiple options for a user to select from 301.

When a selection is made (e.g., the agent selection such as that shown in FIG. 3 at 301), an embodiment identifies a particular data structure within a database associated with that selection. These data structures may include various rules associated with the selection. For example, based on the agent selection, a data structure stored within a database may identify all available bonds sold by that particular agent. It should be understood that the data structures might contain any information relative to bond and bond sales (e.g., geographical limitations, statutory regulations, bond availability, application process, etc.). Additionally, in one embodiment, the user selection may alter or update the potential available selections from the other options (e.g., states, bond classes, bond categories, etc.) based on the identified data structures.

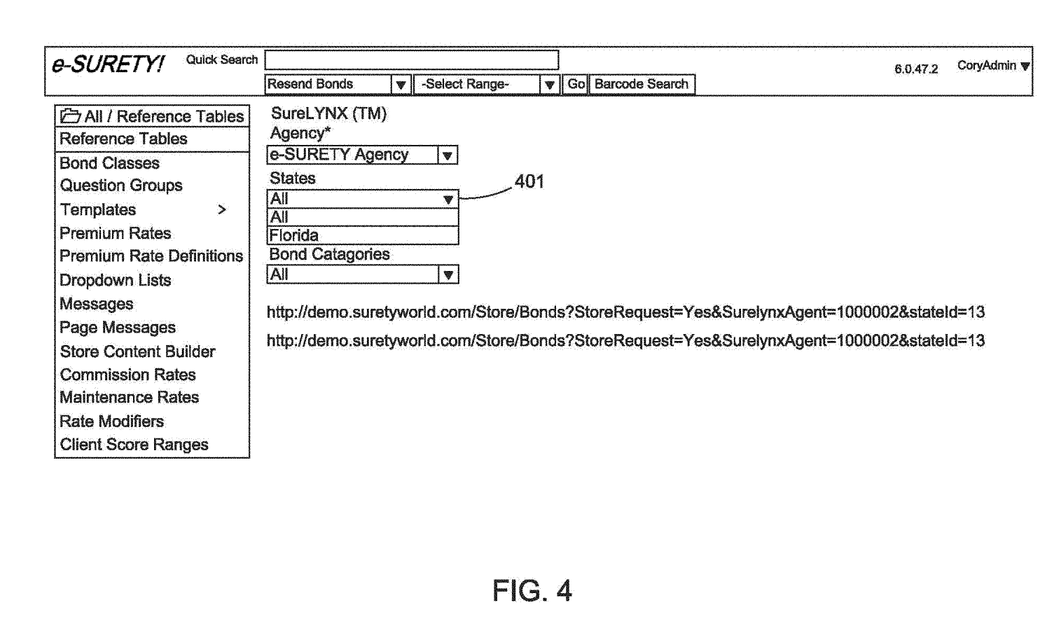

As shown in FIG. 4, in a further embodiment, a user (e.g., surety bond carrier) may select a state from the dropdown list of available states 401 (see 103 in FIG. 1). As discussed herein, user selections may affect what is displayed as an available option in a current dropdown. Thus, for example, if a user selects an agency from a dropdown list of available agencies 301 (see 102 in FIG. 1) prior to selecting the state, the options shown in the state specific dropdown 401 may be filtered based on the availability of the selected agent in each state. Stated differently, after a user selects an Agency, each subsequent dropdown may have its content filtered by what has been assigned to the Agency. By way of non-limiting example, e-SURETY Agency may be licensed in the states of Florida and Georgia only. In a further example, all bonds assigned to Florida and Georgia may be assigned to e-SURETY agency to sell. Thus when “e-SURETY” agency is selected, the states dropdown list is populated only with Florida and Georgia. When one of those two states is selected, only the Bond Classes assigned to that state are populated, and so on.

Additionally or alternatively, it should further be understood that the order in which details of the store content builder are selected may be inconsequential to the result, and that the order presented herein is for illustrative purposes only. For example, a user may select the state prior to selecting an agent, bond class prior to selecting a state, etc.

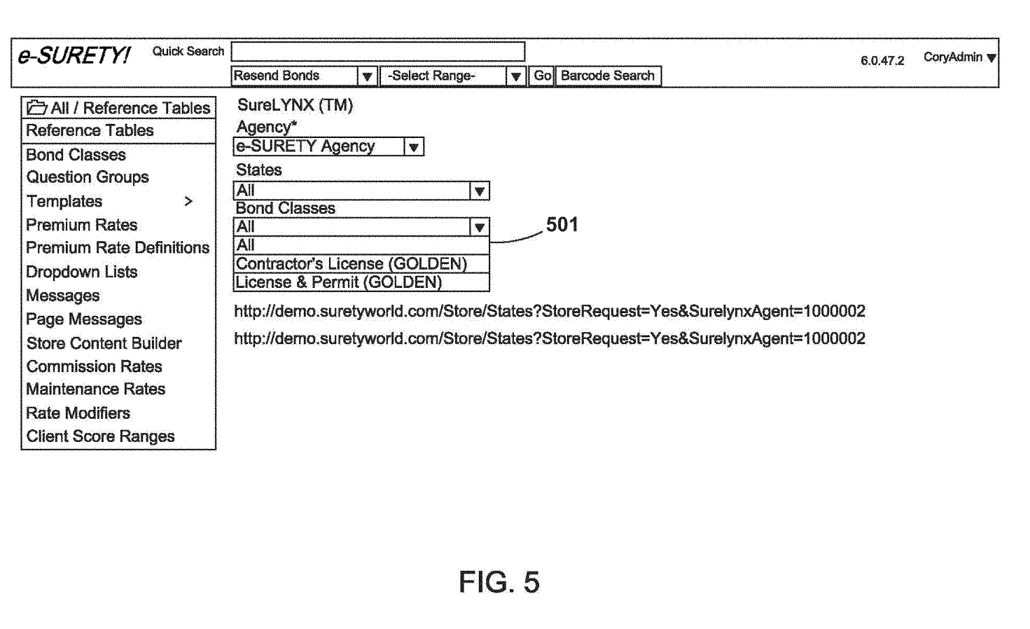

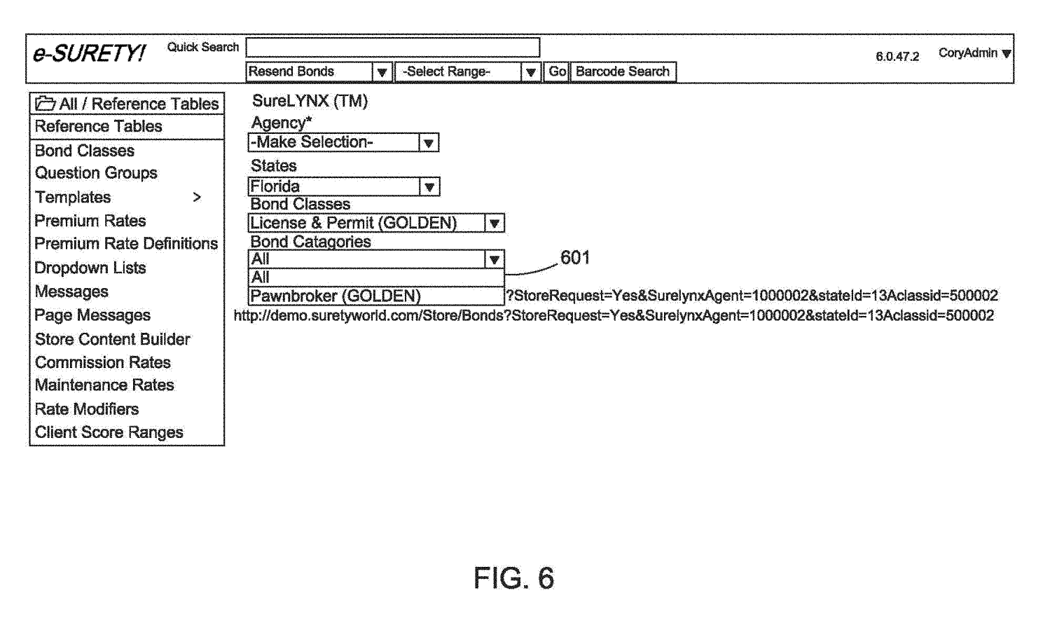

In another embodiment, a user (e.g., surety bond carrier) may select a type of bond class (see 104 in FIG. 1). For example, as shown in FIG. 5, an embodiment may allow a user to select from various bond classes (e.g., contractor's license, license & permit, etc.) using a dropdown menu 501. Once a bond class is selected, a further embodiment may allow a user to narrow the bond based on a “bond category” (See 105 in FIG. 1). For example, as shown in FIG. 6, an embodiment may allow the selection of a bond category from a drop down list 601.

Once all of the desired selections have been made (e.g., 101-105), an embodiment may create a customized website storefront, discussed further herein. This customized website storefront may then be stored on a storage device in a webpage format, using any preferred coding method (e.g., HTML5, CSS3, Flash, Java Script, jQuery, Silverlight, AJAX, etc.). JAVA SCRIPT is a registered trademark of Sun Microsystems, Inc. in the United States of America and other countries. JQUERY is a registered trademark of Software Freedom Conservancy Corporation in the United States of America and other countries. SILVERLIGHT is a registered trademark of Microsoft Corporation in the United States of America and other countries.

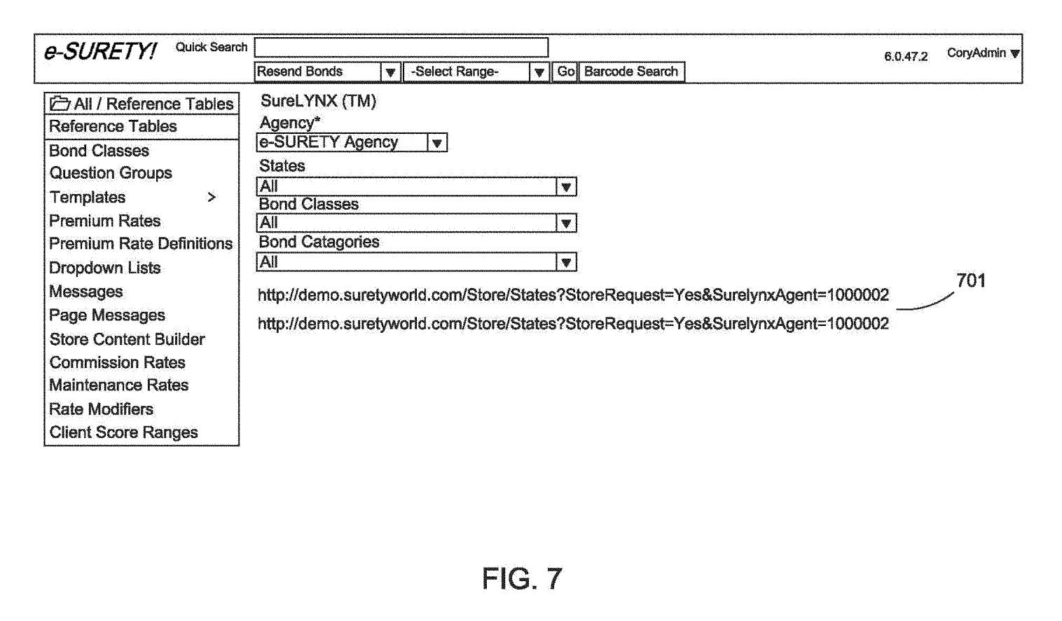

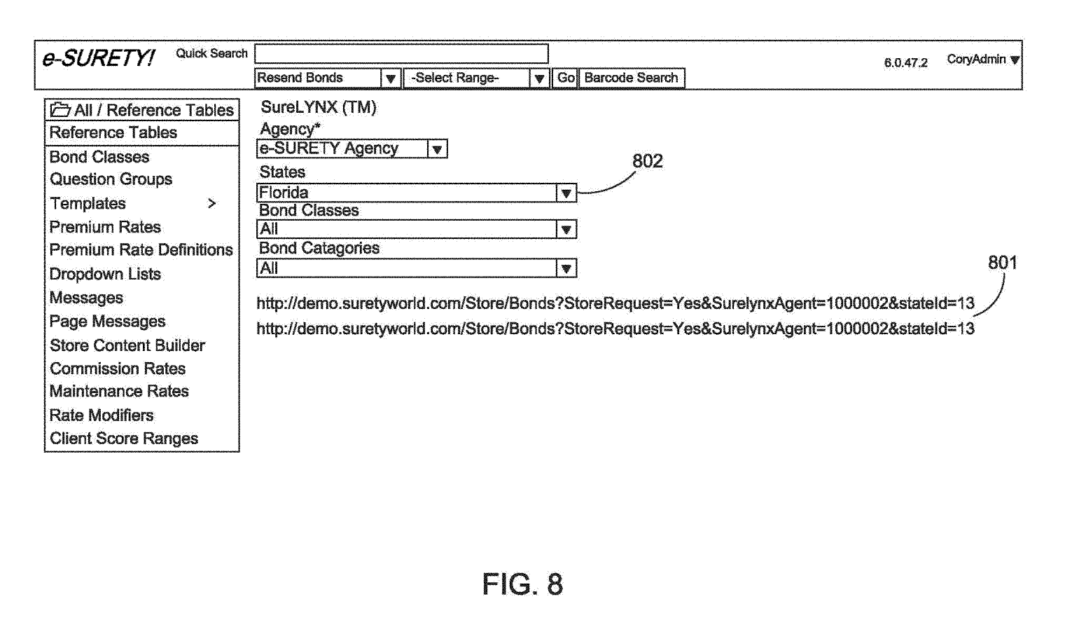

An embodiment may then generate a uniform resource locator (URL) that links to the customized website storefront (see 106 in FIG. 1). As shown in FIGS. 7-10, the URL is automatically updated as selections are made. Thus, in an embodiment, once a user has made a specific selection, the customized website storefront is modified, and the displayed URL is updated. For example, the URL shown at 701 would include a storefront that contained all bonds sold by the “e-surety Agency.” Alternatively, by selecting the state (e.g., Florida) 802, an entirely new customized website storefront is created and the URL is updated to reflect the change and state selection 801.

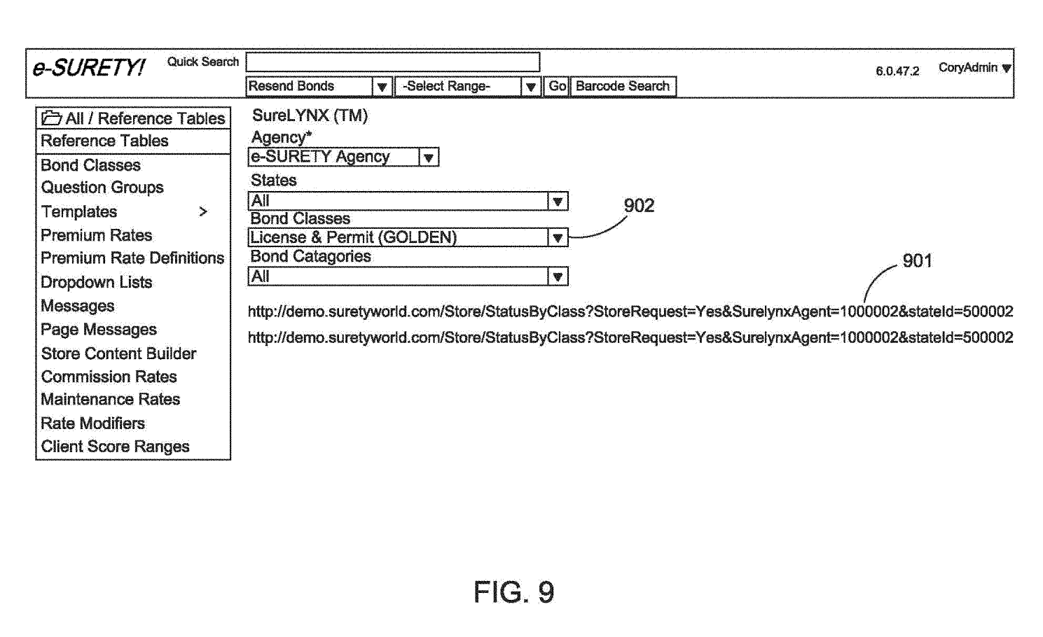

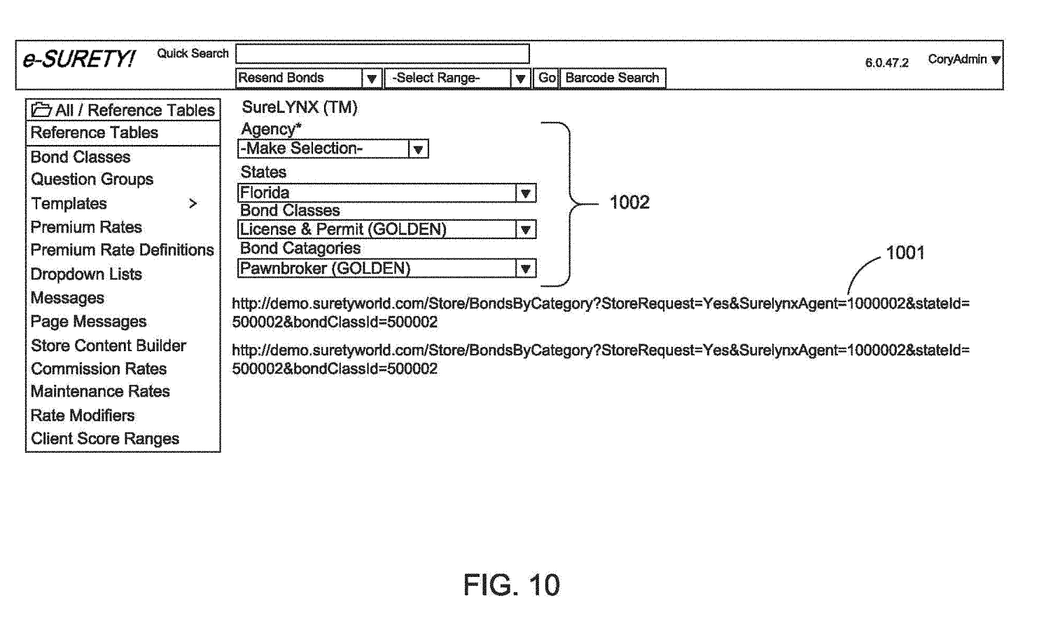

Similarly, if a user selects a bond class (e.g., License & Permit) 902, the URL shown at 901 would include all bonds sold by the “e-surety Agency.” Additionally, as discussed herein, if a user selects one characteristic, it may narrow a second characteristic. Moreover, if a user selects two characteristics as shown in FIG. 9, it has a similar effect on the remaining characteristics, as well as modifies the customized website storefront and corresponding URL 901. Thus, as shown in FIG. 10, once all desired selections are made 1002, a final URL 1001 may be generated and displayed, which corresponds to a user's desired customized website storefront.

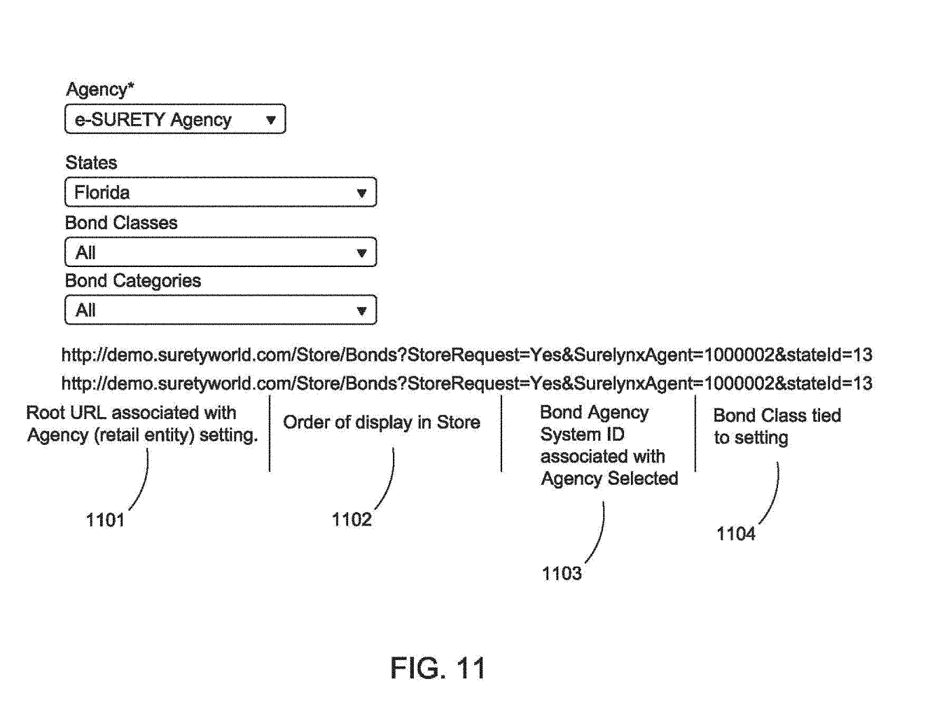

Referring to FIG. 11, a non-limiting illustrative example describing how the URL may be generated is shown. For example, in one embodiment, the root URL may be associated with the selected agency 1101. The second portion of the URL may indicate an order to be displayed within the customized website storefront 1102. In a further embodiment, a bond agency system identification number associated with the agency selected at 301 may be included in the URL 1103. Finally, a bond class or bond class identification number may be included in the URL to identify the user selected bond class or type 1104. As discussed herein, not all of the selections are required. Thus, the generated URL may have more or less sections than discussed above, based on the number of options selected.

In one embodiment, the customized storefront may have many options to mix and match various displayed content. For example, an administrator may be able to select from various interface templates, which affect the initial display of the content of the store that a consumer would see when accessing the store via a web browser (e.g., a simplified log in page, or information-filled log in page). Additionally, if a consumer is accessing the store for the first time, they may be required to establish an account with access credentials. Thus, an embodiment provides an administrator with the ability to determine what order pages are displayed, what is displayed on those pages, and how those pages may differ for users based on a specific user's previous interaction with the customized storefront.

Accordingly, as discussed herein, an embodiment provides a computerized method for automatically generating a customized website storefront based on one or more obtained bond characteristics (e.g., directly from a user via a graphical user interface (GUI), from a third party application, from a prepopulated form/document, or the like). Once the bond characteristics are received (e.g., as shown in FIGS. 3-6), an embodiment may automatically identify, from a reference table database, one or more data structures based on the one or more bond characteristics. The data structures, as discussed in detail herein, may then be used by a store content builder to automatically generate a customized website storefront. The generated website storefront is then stored in a storage device (e.g., a server) and a uniform resource locator (URL) may be generated, which identifies the location of the stored storefront.

Thus, an embodiment enables carriers and their agency partners to deliver content (e.g., bonds) to a website(s) (e.g., an agent's website) in a web-based format to facilitate consumer use in acquiring and managing bond(s) (e.g., application, payment, management, etc.). In one embodiment, each customized website storefront may contain bond specific content (e.g., inventory) defined by one or more system administrators. The customized website storefront(s) may then be deployed to any website via the specially crafted URL that identifies the storefront content 107, for example, in an email, agent portal, consumer website, or any combination thereof.

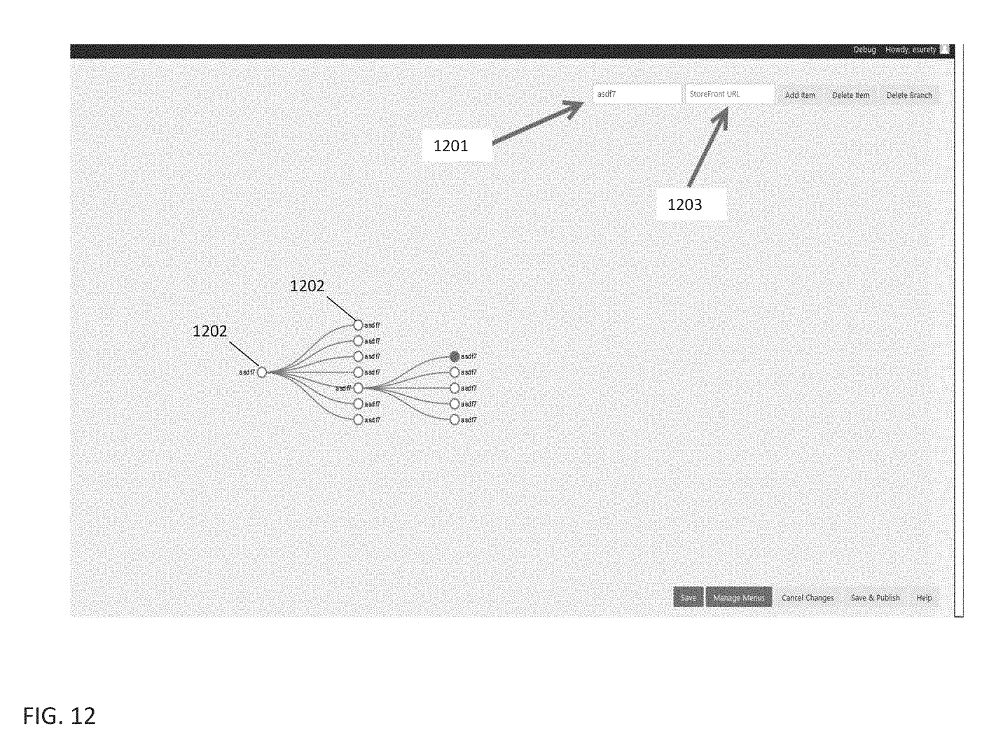

For example, and as shown in FIG. 12, a Menu Builder may be used to define the one or more menus 1201 and site map options. As shown in FIG. 12, each node 1202 may be created automatically as a user creates and defines a page in the database. In some embodiments, a user may be able to enter or automatically populate the required code (e.g., Iframe, JavaScript, etc.) to display the store content delivered via the SureLYNX Url 1203. Because each individual page can represent a specific bond product, category, or class, it can be embedded with customized specific search engine optimization (SEO) metadata and given an SEO compatible URL.

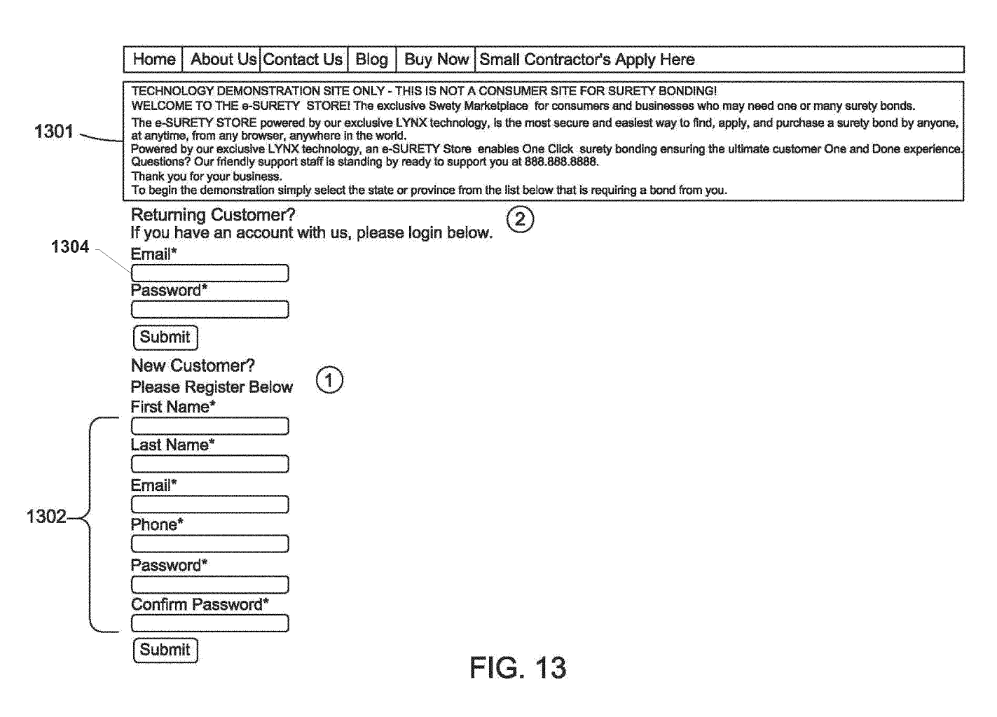

Referring to FIG. 13, in one embodiment, once the URL of the customized website storefront has been created and the website has been published, as discussed herein, the storefront may be displayed, as shown in FIG. 13, to one or more users (e.g., agent(s), consumer(s), etc.). A user may then enter their credentials into fields 1304 in the customized website storefront, and log into the storefront to manage any existing bonds, make a purchase (e.g., a consumer), or facilitate a purchase for another individual (e.g., an agent). Alternatively, a user may need to first create a user profile if they have not previously logged in or purchased a bond from the current agent or carrier storefront. For example, as shown in FIG. 13, an embodiment may present a new user with a welcome message 1301 that may also provide a demonstration. In a further embodiment, each message may be uniquely generated using the store content builder. For example, the customer support number may be altered based on the agent selling the currently selected bond. An embodiment may also provide a new user registration area 1302, wherein a user can enter their information and register for a new account.

Once logged in, a user may see their user identification, and/or an identifier indicating their status (e.g., agent, consumer, etc.) 1401. A user may then proceed to search for a desired bond to purchase in various ways. For example, in one embodiment, a user may simply enter some search criteria into the “free form search” bar 1402, and search the available bond database associated with this particular customized website storefront. As discussed herein, the generation of the storefront may be based on various bond characteristics, and thus, each website storefront may provide different types of bonds for sale. Additionally or alternatively, a user may search for an available bond using a series of drop down menus (e.g., bond family, state of purchase, bond class, bond categories, obligees, carriers, etc.) 1403. In one embodiment, the drop down menus are determined based on a particular storefront's inventory (e.g., generated via the store content builder), and thus a user may have a totally unique or different experience when using different customized website storefronts.

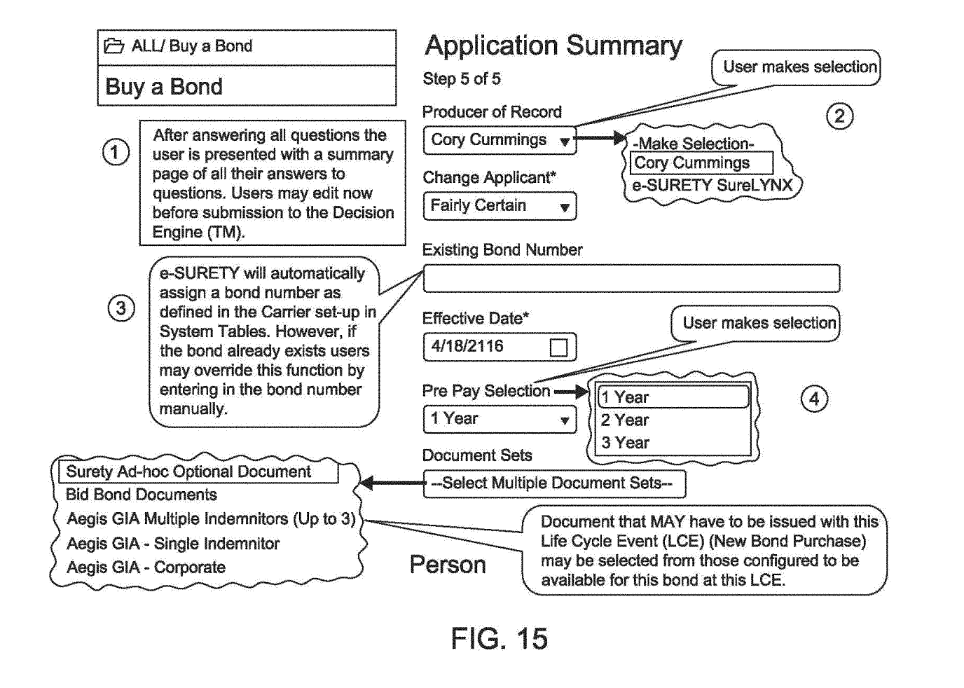

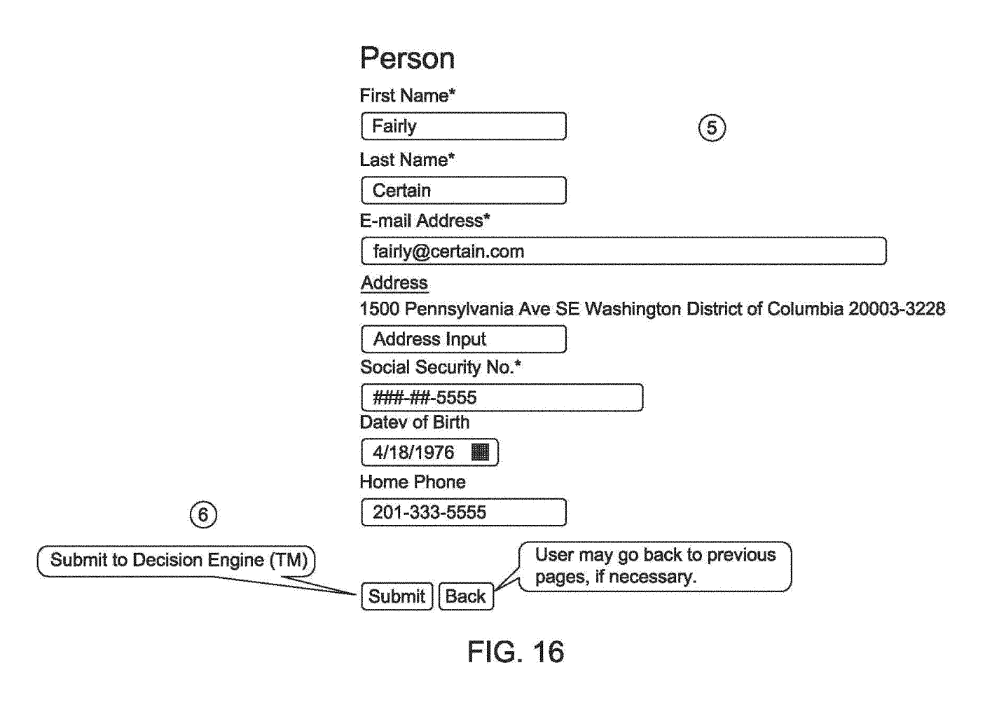

In a further embodiment, the system is able to determine what forms a user is going to require in order to purchase a bond they selected using a method similar to those discussed herein. For example, as shown in FIGS. 15 and 16, a user may need to enter various information into an application form. The requirements to buy a bond can be based on a variety of difficult to understand concepts and regulations. Thus, an embodiment utilizes the various data structures associated with each bond, as discussed herein, to determine what information will be required from the user (e.g., dates, prepay selections, name, address, social security number, date of birth, etc.). The required forms and/or information requested are then presented to the user via a GUI (e.g., FIGS. 15-16).

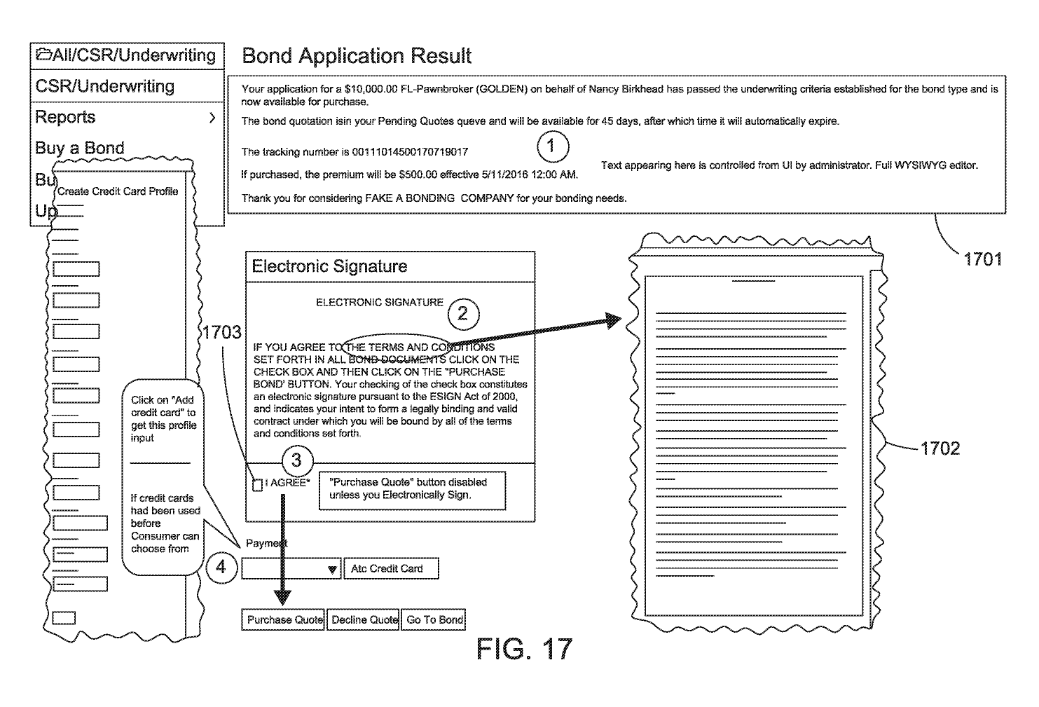

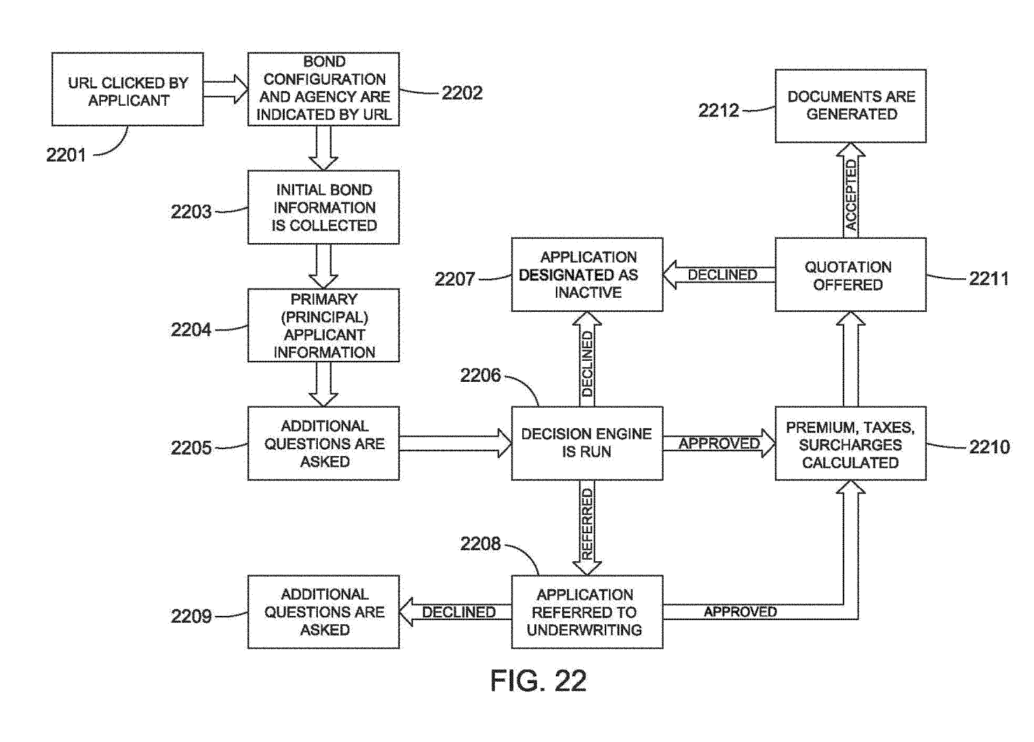

In a further embodiment, once all of the user information has been collected (e.g., using forms similar to that shown in FIGS. 15 and 16); a user may be informed of the application result, such as that shown in FIG. 17. It should be understood, that these figures are only for illustrative purpose, and that the graphical user interface (GUI) displayed to a user may be varied in many ways, for example, the form fields may be in a single page, or spread across multiple pages. In one embodiment, a user may be approved, based on the information collected, for the purchase of one or more bonds 1701. Based on this approval, an embodiment may prompt the user to accept certain terms and agreements 1702. The terms and agreements 1702 are generally determined based on the state laws and regulation governing the sale of the particular bond purchased. Thus, an embodiment must again determine based on various factors (e.g., the inventory of the custom storefront, the desired bond characteristics of a purchaser, etc.) what must be included in the terms and conditions. Once the terms have been displayed, a user may accept the terms via a check box 1703, and move forward with the bond purchase. The bond purchase process is further detailed herein at FIG. 22.

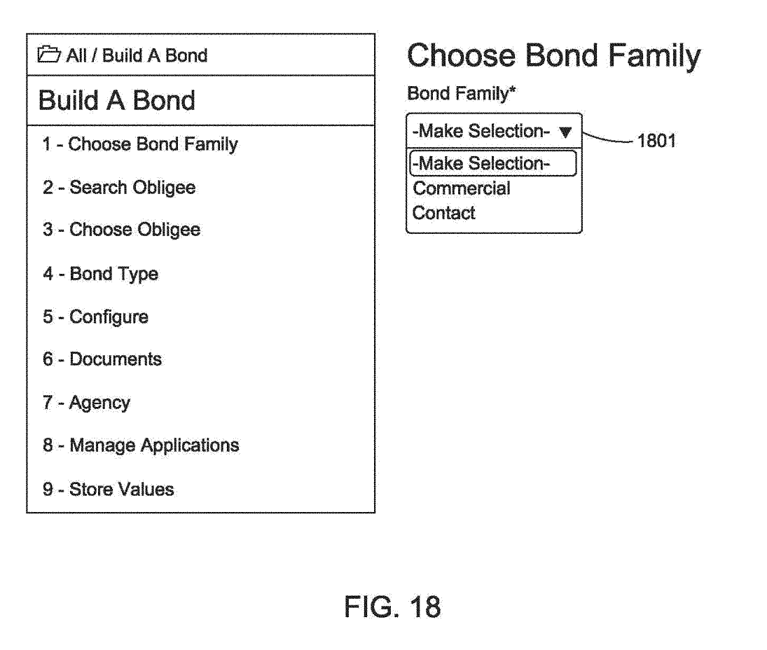

In addition to bond purchases and management, an embodiment may also allow the creation of a bond entry into the system. For example, if a new bond is created or permitted via a government regulatory agency, an embodiment may allow a user to update the data structures in the database to include the new bond type. The creation of a new bond entry then allows the new bond to be included in subsequent customized website storefront(s) for sale. Referring now to FIG. 18, an embodiment may allow a user (e.g., carrier, agent, administrator, etc.) to create a bond using a graphical user interface (GUI). By way of non-limiting illustrative example, a user may begin by selecting a bond family (e.g., commercial, contract, etc.) 1801. Additionally or alternatively, a user may select to build a bond based on obligee, type, Agency, etc.

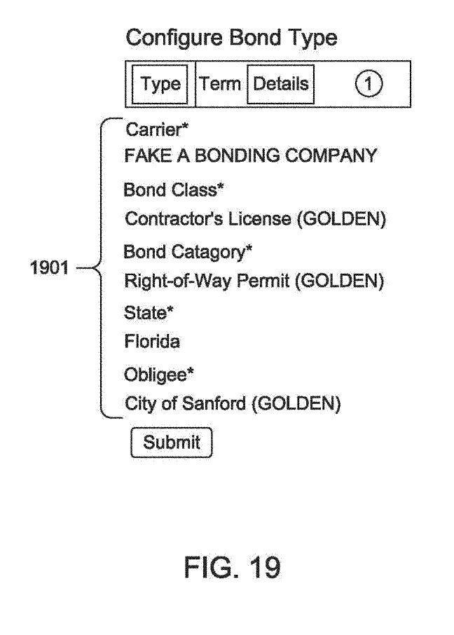

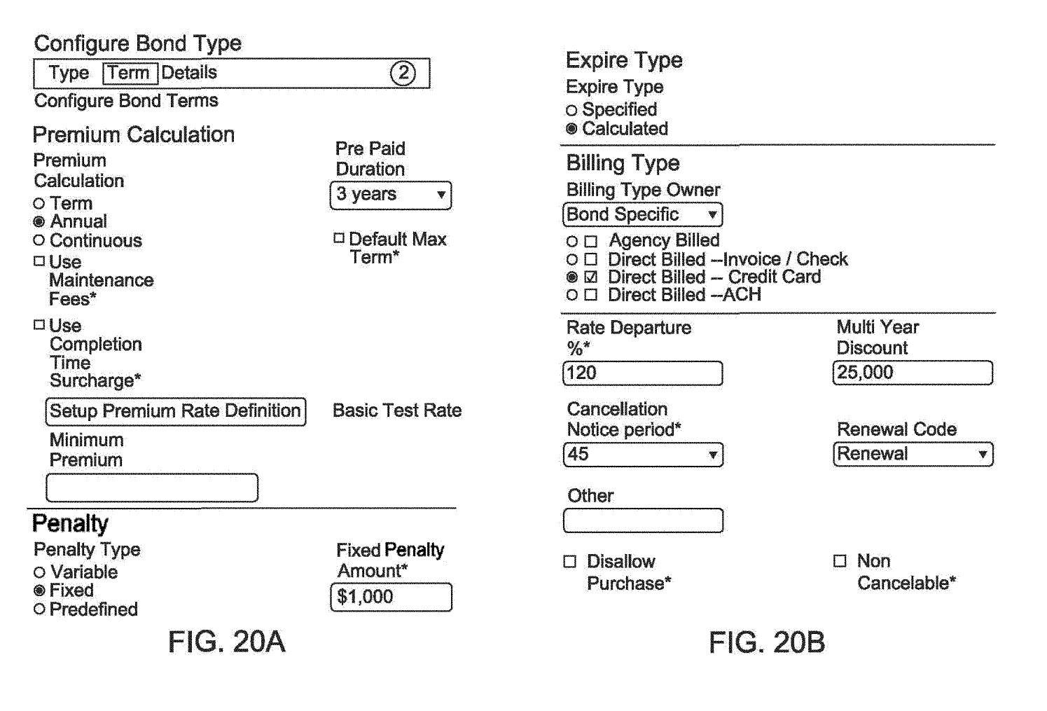

For example, a user may begin the creation of a bond entry by entering information regarding the bond type, such as in FIG. 19. The bond type information 1901 may include, but is not limited to a designated carrier, a bond class, a bond category, a state the bond is associated with, an obligee, and the like. Referring now to FIGS. 20A and 20B, an embodiment may allow for further configuration of a bond entry. By way of non-limiting example, an embodiment may accept information relative to the premium calculation, such as intervals (e.g., term, annual, continuous, etc.), if maintenance fees apply, if a completion time surcharge is included, if there is a minimum premium, and the like. A further embodiment may consider penalty type (e.g., variable, fixed, predefined, etc.). Other factors considered by various embodiments may include, but are not limited to, expiration type (e.g., specified or calculated), billing type (e.g., agency, direct, etc.), rate departure, multiyear discount, cancellation notice period, renewal code, and the like.

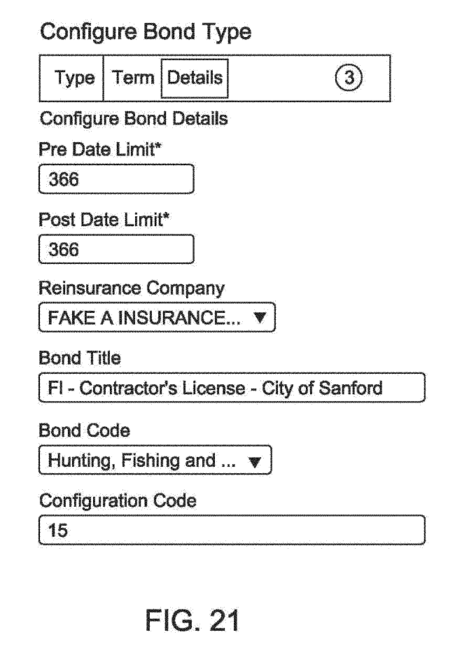

Another embodiment, as shown in FIG. 21, may allow for even further refinement related to the creation of a new bond category, such as, pre-date limit, post-date limit, reinsurance company, bond title, bond code, configuration code, and the like.

An illustrative example bond purchasing process is shown in FIG. 22. In one embodiment, initially, an applicant may click a URL at 2201. This may begin the bond purchase process. Based on the URL that was clicked, a bond configuration and agency may be identified at 2202. The bond configuration may describe unique characteristics of the bond such as, commission, documents, questions, and rules and the agency selection allows an embodiment to determine which agency can manage the bonds available for purchase. An embodiment, such as those described herein may utilize various tables to determine each characteristic. A non-limiting example of tables used may include: BondTypes, BondClasses, BondCategories, BondAgencyCommissions, PremiumRateDefinitions, PremiumRateDefinition-Items, PremiumRateDefinitionDetails, PremiumRates, PremiumRateEffectiveDates, PremiumRateItems, DecisionRules, DecisionRuleInputs, DecisionRuleModifiers, DecisionRuleExpressions, DocumentSets, DocumentSetTemplates, DocumentSetTemplateData, DocumentSetDocumentTemplates, Questions, QuestionTemplates, QuestionTemplateLifeCycleEvents, QuestionGroups, QuestionGroupTemplates, etc.

Once the bond configuration and agency are selected at 2202, initial bond information may be collected at 2203. The initial bond application information is collected, which may be used to determine the price of the bond. In one embodiment, the information collected during this step (2203) is controlled by the bond configuration. The information collected by an embodiment may vary, but a few non-limiting examples may include Penalty Amount (e.g., electing an amount from a dropdown), Bond Term (i.e., how long the term of the bond is), Industry Type (e.g., plumber, electrician, etc.), Principle Type (e.g., whether the principal (name on the bond) is a company or an individual), etc. An embodiment, such as those described herein may utilize various tables to collect initial bond information. A non-limiting example of tables used may include BondTypes, PremiumRateDefinitions, PremiumRateDefinitionItems, PremiumRateDefinitionDetails, etc.

In addition to bond information, principle information is collected from the applicant 2204. Principle information may include, for example, identity information (e.g., name, address, phone, etc.), information needed to pull a credit report and/or other third party information, such as a SSN (Social Security Number). In a further embodiment, additional information may be deemed required by the bond administrator to better determine a price and/or decide whether to issue the bond (e.g., number of years in business, etc.). An embodiment, such as those described herein may utilize various tables to collect principle information. A non-limiting example of tables used may include BondPeople, BondPeoplePartner, BondCompanies, BondCompaniesPartner, Questions, QuestionTemplates, QuestionTemplateLifeCycleEvents, etc. An embodiment may utilizes a specific framework to present a graphical user interface (GUI) comprising questions based on the data in the above tables. In one embodiment, the framework may support multiple types of input (e.g., dropdown, radio buttons, numeric input, etc.) as well as dynamic validation (i.e., making sure an email is correctly structured and all required data is entered).

Once the bond, agency, and principle information is collected, additional questions may be presented to the user 2205. In one embodiment, a Bond Administrator may create these questions. Additionally, the questions may be specific to the bond (e.g., specific data that may be required to create the bond forms and documents). The questions may be used to gather information to assist a decision engine (e.g., for pricing, to determine whether to auto-decline, auto-approve, refer the bond, etc.). An embodiment, such as those described herein may utilize various tables to collect the additional information. A non-limiting example of tables used may include Questions, QuestionTemplates, QuestionTemplateLifeCycleEvents.

After all the information (e.g., bond configuration, agency, principle, etc.) is collected, a decision engine is run 2206. In one embodiment, questions with rules may be submitted from the one or more application fields (e.g., information entered into the GUI, as described herein) to the decision engine or from “system” set rules (e.g., where third party data is collected and analyzed). In a further embodiment, all of the data discussed above may be used by the decision engine to evaluate if a bond should be automatically approved, rejected outright, or referred to an underwriter for manual review. If a bond is approved (e.g., automatically or manually), the answers to the questions, or values pulled in from outside sources (e.g., a credit score), can be used to adjust the pricing of the particular bond. For example, having a lower credit score can result in a price increase and/or being in business for a longer period of time may reduce the price or provide a discount. An embodiment, such as those described herein may utilize various tables during the execution of the decision engine. A non-limiting example of tables used may include DecisionRules, DecisionRuleInputs, DecisionRuleModifiers, DecisionRuleExpressions.

During the execution of the decision engine 2206, various outcomes are possible. In one embodiment, an application may be designated inactive 2207. This may happen when the decision engine returns a ‘Rejected’ value. Thus, a new BondAction may be recorded that has a status of Rejected, which also marks the bond status as Inactive. An embodiment, such as those described herein may utilize various tables during the execution of the decision engine. A non-limiting example of tables used to designate an application inactive 2207 may include Bonds, BondActionLogs, BondDetails, BondQuestionDecisionHistory, etc.

Additionally or alternatively, an embodiment may refer to the application to underwriting 2208. This may happen when the decision engine returns a ‘Referred’ value. Thus, a new BondAction may be recorded that has a status of Referred, which also marks the bond status as Inactive. An embodiment, such as those described herein may utilize various tables during the execution of the decision engine. A non-limiting example of tables used to refer an application and mark it inactive 2208 may include Bonds, BondActionLogs, BondDetails, BondQuestionDecisionHistory, etc.

When an application is referred to underwriting 2208, additional questions may be asked 2209. In one embodiment, a Bond Administrator may create these questions. In a further embodiment, the additional questions may be specific to the bond (e.g., often specific data is required to create the bond forms and documents). An embodiment, such as those described herein may utilize various tables during the collection of additional information via the additional questions. A non-limiting example of tables used may include Questions, QuestionTemplates, QuestionTemplateLifeCycleEvents, etc.

Another option for the outcome of the execution of the decision engine 2206 may be that the application is automatically approved and premium, taxes, and surcharges are calculated 2210. In one embodiment, the total premium (i.e., price) may be calculated using bond configuration data determined by: the Bond Administrator (e.g., premium rate definitions and rates), information input by the applicant (e.g., bond penalty amount, term of the bond, values tied to premium rate definitions such as industry type, etc.), and the modifier provided by the decision engine 2206. An embodiment, such as those described herein may utilize various tables during the execution of the decision engine. A non-limiting example of tables used to automatically approve the application and calculate the premium, taxes, and surcharges 2210 may include BondAgencyCommissions, PremiumRateDefinitions, PremiumRateDefinitionItems, PremiumRateDefinitionDetails, PremiumRates, PremiumRateEffectiveDates, PremiumRateItems, etc.

Once the premium, taxes, and surcharges are calculated 2210, an embodiment may offer a quotation to a user 2211. In one embodiment, the calculated premium and term are presented to the user (e.g., utilizing a graphical user interface) as a quote that can be accepted. An embodiment, such as those described herein may utilize various tables during the collection of offering of a quotation. A non-limiting example of tables used may include Bonds, BondActionLogs, BondDetails, etc.

Finally, if the application is approved (e.g., via automatic approval or underwriting specialist), the premium, taxes, and surcharges are calculated 2210, and the quotation is offered 2211 and accepted. Once accepted, a user may enter payment information in order to acquire a particular bond. After payment is received, an embodiment may generate the required documents for the bond purchase 2212. In one embodiment, documents may be associated with each configuration and Bond Life Cycle Event in two ways. In the first, multiple documents may be associated with each Configuration for each Life Cycle Event. In the second, additional documents relevant to the specific configuration or generally relevant to any bond may be manually selected by an agent (e.g., underwriter) from a list of “Supplemental Documents,” which may be presented via a graphical user interface (GUI).

In a further embodiment, all data related to the bond may be available for use when creating bond forms and documents. Some non-limiting examples of available data may include bond configuration fields (e.g., Bond Class Name and Description), data collected from the applicant (e.g., both initial bond information and the answers to all questions), values calculated (e.g., the premium charged), etc. Custom functions may also be available to help format the data as desired such as spelling out numeric data. This is necessary because often bond relevant information (e.g., the ‘penalty charged’) may be written out on the Bond Form in a non-uniform way (e.g., like you would write the dollar amount on a check, date display formatting, concatenating fields and address information. etc.). An embodiment, such as those described herein may utilize various tables during generation of documents. A non-limiting example of tables used may include DocumentSets, DocumentSetTemplates, DocumentSetTemplateData, DocumentSetDocumentTemplates, etc.

As discussed herein, Bond “Life Cycle Events” may include, but are not limited to: a new bond application, manual renewal or auto renewal (e.g., system parameters set by the Administrator that if met will result in an automatic renewal or renewal Quotation), cancellation initiation, reinstatement, final cancel, premium bearing rider (e.g., a series of questions or changes to bond parameters, such as effective date, expiry date, bond amount, number of years prepaid, etc.), non-premium bearing rider (e.g., a series of questions that changes data on a bond that does not affect premium such as, applicant address, etc.).

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider).

Aspects of the present invention are described herein with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which are executed on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

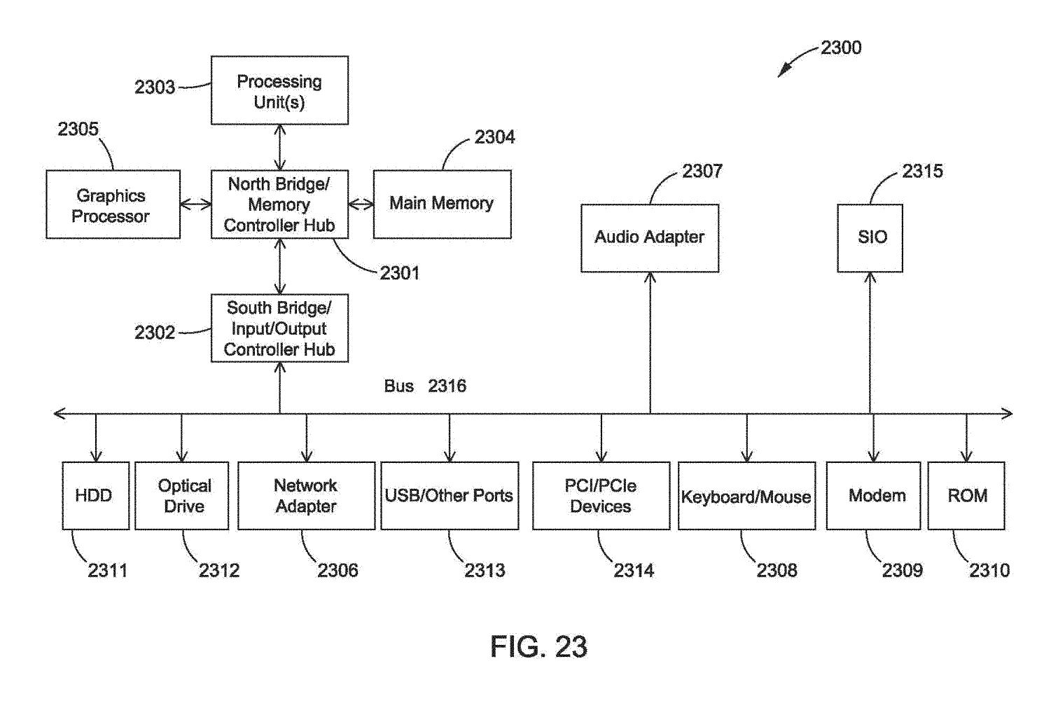

FIG. 23 is a block diagram of an example data processing system 2300 in which aspects of the illustrative embodiments are implemented. Data processing system 2300 is an example of a computer, such as a server or client, in which computer usable code or instructions implementing the process for illustrative embodiments of the present invention are located. In one embodiment, FIG. 23 may represent a server computing device.

In the depicted example, data processing system 2300 can employ a hub architecture including a north bridge and memory controller hub (NB/MCH) 2301 and south bridge and input/output (I/O) controller hub (SB/ICH) 2302. Processing unit 2303, main memory 2304, and graphics processor 2305 can be connected to the NB/MCH 2301. Graphics processor 2305 can be connected to the NB/MCH 2301 through, for example, an accelerated graphics port (AGP).

In the depicted example, a network adapter 2306 connects to the SB/ICH 2302. An audio adapter 2307, keyboard and mouse adapter 2308, modem 2309, read only memory (ROM) 2310, hard disk drive (HDD) 2311, optical drive (e.g., CD or DVD) 2312, universal serial bus (USB) ports and other communication ports 2313, and PCI/PCIe devices 2314 may connect to the SB/ICH 2302 through bus system 2316. PCI/PCIe devices 2314 may include Ethernet adapters, add-in cards, and PC cards for notebook computers. ROM 2310 may be, for example, a flash basic input/output system (BIOS). The HDD 2311 and optical drive 2312 can use an integrated drive electronics (IDE) or serial advanced technology attachment (SATA) interface. A super I/O (SIO) device 2315 can be connected to the SB/ICH 2302.

An operating system can run on processing unit 2303. The operating system can coordinate and provide control of various components within the data processing system 2300. As a client, the operating system can be a commercially available operating system. An object-oriented programming system, such as the Java™ programming system, may run in conjunction with the operating system and provide calls to the operating system from the object-oriented programs or applications executing on the data processing system 2300. As a server, the data processing system 2300 can be an IBM® eServer™ System p® running the Advanced

Interactive Executive operating system or the Linux operating system. The data processing system 2300 can be a symmetric multiprocessor (SMP) system that can include a plurality of processors in the processing unit 2303. Alternatively, a single processor system may be employed.

Instructions for the operating system, the object-oriented programming system, and applications or programs are located on storage devices, such as the HDD 2311, and are loaded into the main memory 2304 for execution by the processing unit 2303. The processes for embodiments described herein can be performed by the processing unit 2303 using computer usable program code, which can be located in a memory such as, for example, main memory 2304, ROM 2310, or in one or more peripheral devices.

A bus system 2316 can be comprised of one or more busses. The bus system 2316 can be implemented using any type of communication fabric or architecture that can provide for a transfer of data between different components or devices attached to the fabric or architecture. A communication unit such as the modem 2309 or the network adapter 2306 can include one or more devices that can be used to transmit and receive data.

Those of ordinary skill in the art will appreciate that the hardware depicted in FIG. 23 may vary depending on the implementation. Other internal hardware or peripheral devices, such as flash memory, equivalent non-volatile memory, or optical disk drives may be used in addition to or in place of the hardware depicted. Moreover, the data processing system 2300 can take the form of any of a number of different data processing systems, including but not limited to, client computing devices, server computing devices, tablet computers, laptop computers, telephone or other communication devices, personal digital assistants, and the like. Essentially, data processing system 2300 can be any known or later developed data processing system without architectural limitation.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112(f) unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as they fall within the true spirit and scope of the invention.

What is claimed is:

1. A method for automating the creation of a customized website storefront comprising:
obtaining, using a processor, one or more bond characteristics;
automatically identifying, from a reference table database, one or more data structures based on the one or more bond characteristics;
automatically generating, using a store content builder, a customized website storefront based on the data structures;
storing, in a network connected storage device, the customized website storefront; and
generating, based on the one or more bond characteristics, a uniform resource locator (URL) to locate the stored customized website storefront.

2. The method of claim 1, wherein the one or more bond characteristics comprise at least one of a bond type, a bond term, and a bond detail.

3. The method of claim 2, wherein the bond type comprises at least one of a carrier, a bond class, a bond category, a state, and an obligee.

4. The method of claim 2, wherein the bond term comprises at least one of a calculation type, a penalty type, an expire type, and a billing type.

5. The method of claim 2, wherein the bond detail comprises at least one of pre-date limit, post-date limit, reinsurance company, bond title, bond code, and configuration code.

6. The method of claim 1, further comprising, displaying, on a display device, a summary page comprising the one or more bond characteristics.

7. The method of claim 1, further comprising publishing, using the URL, the customized website storefront in at least one of an email, a new standalone website, and an existing website.

8. The method of claim 7, wherein the publishing comprises, displaying, on a display device, a graphical user interface (GUI) comprising a user login screen.

9. The method of claim 7, wherein the published customized website storefront obtains a bond purchase request, comprising bond purchase characteristics.

10. The method of claim 9, wherein the published customized website storefront automatically identifies one or more applicable forms to enable a user to apply for a bond associated with the bond purchase request.

11. An information handling device for automating the creation of a customized website storefront comprising:
a processor;
a display;
a network connection device; and
a non-transitory, processor-readable storage medium that stores instructions executable by the processor to:
obtain one or more bond characteristics;
automatically identify, from a reference table database, one or more data structures based on the one or more bond characteristics;
automatically generate, using a store content builder, a customized website storefront based on the data structures;
store the customized website storefront; and
generate, based on the one or more bond characteristics, a uniform resource locator (URL) to locate the stored customized website storefront.

12. The information handling device of claim 11, wherein the one or more bond characteristics comprise at least one of a bond type, a bond term, and a bond detail.

13. The information handling device of claim 12, wherein the bond type comprises at least one of a carrier, a bond class, a bond category, a state, and an obligee.

14. The information handling device of claim 12, wherein the bond term comprises at least one of a calculation type, a penalty type, an expire type, and a billing type.

15. The information handling device of claim 12, wherein the bond detail comprises at least one of pre-date limit, post-date limit, reinsurance company, bond title, bond code, and configuration code.

16. The information handling device of claim 11, wherein the instructions are further executable by the processor to:
publish, using the uniform resource locator, the customized website storefront in at least one of an email, a new standalone website, and an existing website.

17. The information handling device of claim 16, wherein the publishing comprises, displaying, on a display device, a graphical user interface (GUI) comprising a user login screen.

18. The information handling device of claim 16, wherein the published customized website storefront obtains a bond purchase request, comprising bond purchase characteristics.

19. The information handling device of claim 18, wherein the published customized website storefront automatically identifies one or more applicable forms to enable a user to apply for a bond associated with the bond purchase request.

20. A program product for automating the creation of a customized website storefront comprising:
a storage device having code stored therewith, the code being executable by a processor and comprising:
code that obtains one or more bond characteristics;
code that automatically identifies, from a reference table database, one or more data structures based on the one or more bond characteristics;
code that automatically generates, using a store content builder, a customized website storefront based on the data structures;
codes that stores, in a network connected storage device, the customized website storefront; and
code that generates, based on the one or more bond characteristics, a uniform resource locator (URL) to locate the stored customized website storefront.
